(19) United States
(12) Patent Application Publication
(10) Pub. No.: US 2026/0084724 A1
(43) Pub. Date: Mar. 26, 2026

(54) VEHICLE AND VEHICLE CONTROLLER

(71) Applicants: TOYOTA JIDOSHA KABUSHIKI KAISHA, Toyota-shi (JP); DENSO TEN Limited, Kobe (JP)

(72) Inventor: Long YOU, Kobe (JP)

(73) Assignees: TOYOTA JIDOSHA KABUSHIKI KAISHA, Toyota-shi (JP); DENSO TEN Limited, Kobe (JP)

(21) Appl. No.: 19/319,054

(22) Filed: Sep. 4, 2025

(30) Foreign Application Priority Data
Sep. 25, 2024 (JP) 2024-166266

(51) Int. Cl. B60W 60/00; B60T 7/12; B60W 50/14

(52) U.S. Cl. CPC B60W 60/005; B60T 7/12; B60W 50/14; B60W 60/001

(57) ABSTRACT

A vehicle allowing an autonomous driving kit to be mounted thereto comprises a vehicle control interface box and a vehicle system. The vehicle control interface box sends a prohibition signal to the autonomous driving kit while the vehicle is located on a steep slope. The prohibition signal indicates that brake hold by a brake device is prohibited. The vehicle control interface box switches a manual mode to an autonomous mode and vice versa in response to a request received from the autonomous driving kit. The vehicle control interface box continues the manual mode in spite of the autonomous driving kit requesting the vehicle control interface box to switch the manual mode to the autonomous mode while the vehicle is driven in the manual mode and also located on the steep slope.

### CROSS REFERENCE TO RELATED APPLICATIONS

This nonprovisional application is based on Japanese Patent Application No. 2024-166266 filed on September 25, 2024 with the Japan Patent Office, the entire contents of which are hereby incorporated by reference.

### BACKGROUND

### Field

The present disclosure relates to a vehicle allowing an autonomous driving kit to be mounted thereto, and a vehicle controller that controls the vehicle.

### Description of the Background Art

Japanese Patent Laying-Open No. 2021-123139 discloses a vehicle allowing an autonomous driving kit to be mounted thereto. When the autonomous driving kit is attached to the vehicle and uses a Standstill Command to request a vehicle platform (VP) to maintain the vehicle stationary, a vehicle system included in the VP applies brake hold control.

### SUMMARY

The autonomous driving kit allows a vehicle to be autonomously driven. When the vehicle is in a specific situation, however, the autonomous driving by the autonomous driving kit tends to decrease in accuracy. For example, when the vehicle is located on a steep slope, the brake hold may not be continuable for a long period of time. On a steep slope, a brake device (e.g., a hydraulic brake device) may be excessively heated and unable to maintain the vehicle in a stationary status. Therefore, when the vehicle is autonomously driven on the steep hill as it is on a flat road, the vehicle may not necessarily be driven appropriately.

The present disclosure has been made to solve the above problem and contemplates a vehicle also appropriately drivable on a steep slope, and a vehicle controller that also appropriately controls the vehicle on the steep slope.

In one aspect of the present disclosure a vehicle is configured to allow an autonomous driving kit to be mounted thereto. The present vehicle comprises a vehicle control interface box and a vehicle system. The vehicle system includes a brake device configured to decelerate the vehicle. The vehicle control interface box is configured to send a prohibition signal to the autonomous driving kit while the vehicle is located on a steep slope. The prohibition signal indicates that brake hold by the brake device is prohibited. The vehicle control interface box is configured to switch a manual mode to an autonomous mode and vice versa in response to a request received from the autonomous driving kit. The manual mode is a mode in which the vehicle system is under control of a user. The autonomous mode is a mode in which the vehicle system is under control of the autonomous driving kit. The vehicle control interface box is configured to continue the manual mode in spite of the autonomous driving kit requesting the vehicle control interface box to switch the manual mode to the autonomous mode while the vehicle is driven in the manual mode and also located on the steep slope.

The foregoing and other objects, features, aspects and advantages in the present disclosure will become apparent from the following description when taken in conjunction with the accompanying drawings.

### BRIEF DESCRIPTION OF THE DRAWINGS

FIG. 1 shows a schematic configuration of a vehicle according to an embodiment of the present disclosure.

FIG. 2 specifically illustrates a system of the vehicle shown in FIG. 1.

FIG. 3 illustrates the autonomous driving kit shown in FIG. 1 controlling the vehicle to be stationary.

FIG. 4 is a flowchart of mode switching control according to the present embodiment.

FIG. 5 is a flowchart indicating details of first mode switching control indicated in FIG. 4.

FIG. 6 is a flowchart indicating details of second mode switching control indicated in FIG. 4.

### DESCRIPTION OF THE PREFERRED EMBODIMENTS

Hereinafter, an embodiment of the present disclosure will be described more specifically with reference to the drawings. In the figures, identical or equivalent components are identically denoted and will not be described repeatedly.

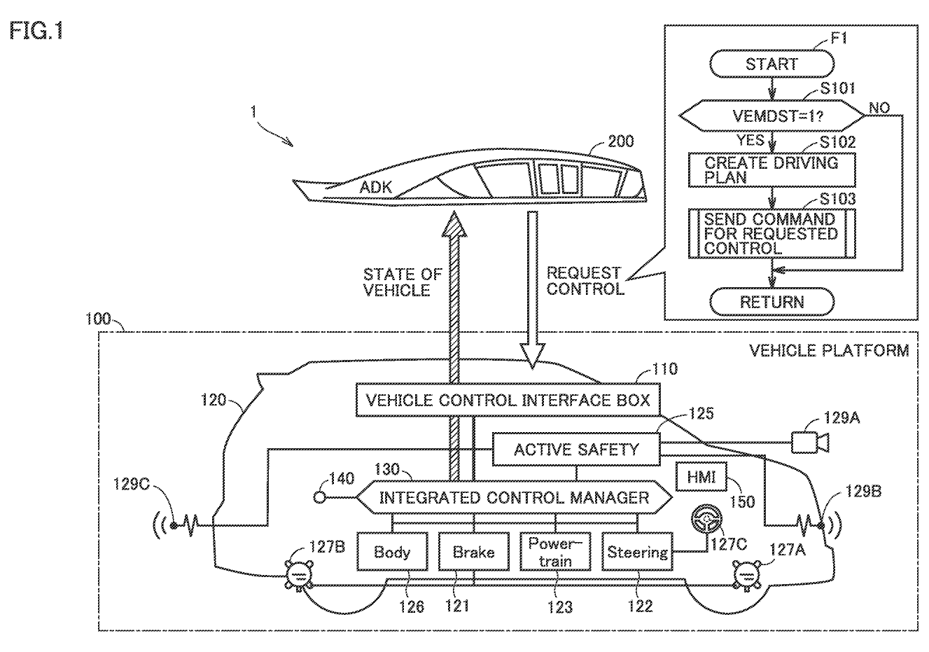

FIG. 1 shows a schematic configuration of a vehicle according to an embodiment of the present disclosure. Referring to FIG. 1, a vehicle 1 comprises a vehicle platform (VP) 100 and an autonomous driving kit (ADK) 200. VP 100 includes a vehicle control interface box (hereinafter denoted as "VCIB") 110 and a base vehicle 120. Adding VCIB 110 to base vehicle 120 forms VP 100 to allow ADK 200 to be detachably attached thereto. VCIB 110 is configured to communicate with both base vehicle 120 and ADK 200 via a communication bus. And attaching ADK 200 to VP 100 completes vehicle 1. In the present embodiment, ADK 200 is attached to the rooftop of base vehicle 120. It should be noted, however, where ADK 200 is attached is changeable as appropriate.

Base vehicle 120 is, for example, a commercially available xEV (electrically driven vehicle). In the present embodiment, a battery electric vehicle (BEV) is employed as base vehicle 120. However, this is not exclusive, and base vehicle 120 may be an xEV other than a BEV. Base vehicle 120 includes an integrated control manager 130, a human-machine interface (HMI) 150, and a variety of types of systems and a variety of types of sensors (wheel speed sensors 127A and 127B, a steering angle sensor 127C, a camera 129A, radar sensors 129B and 129C, an acceleration sensor 140, etc.) for controlling base vehicle 120. Integrated control manager 130 functions as a controller. Integrated control manager 130 operates based on a result of sensing by an in-vehicle sensor to generally control a variety of types of systems relevant to an operation of base vehicle 120. HMI 150 includes an input device and a notification device. Examples of the notification device include a display and a speaker. HMI 150 may include a touch panel display. HMI 150 may include a brake hold switch (hereinafter denoted as "BHSW").

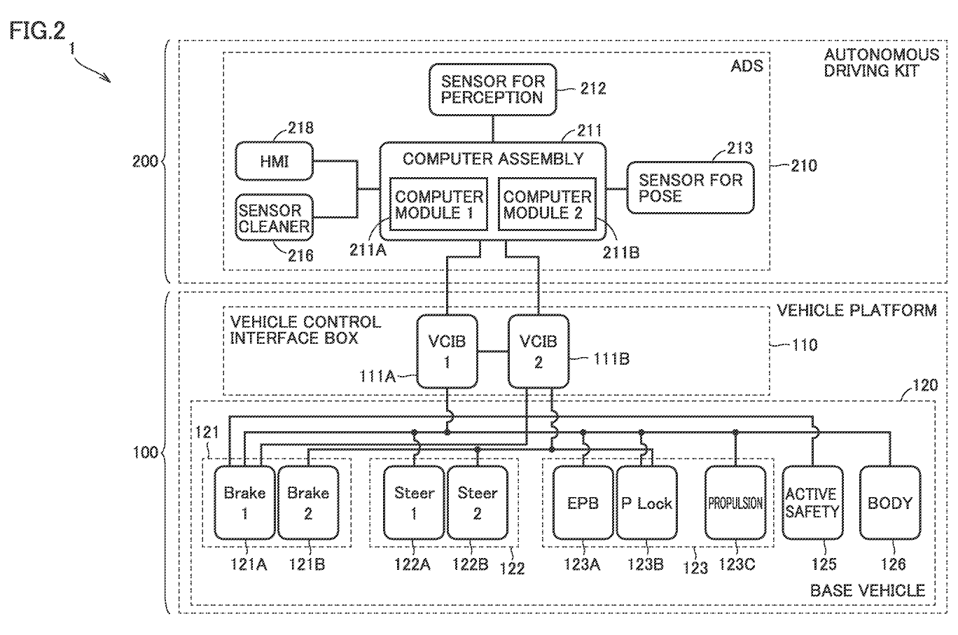

FIG. 2 specifically illustrates a system of vehicle 1. Referring to FIG. 2 together with FIG. 1, ADK 200 includes an autonomous driving system (hereinafter denoted as "ADS") 210 for autonomously driving vehicle 1. ADS 210 includes a computer assembly (hereinafter denoted as "ADSCOM") 211, a sensor for perception 212, a sensor for pose 213, a sensor cleaner 216, and a human-machine interface (HMI) 218.

ADSCOM 211 includes computer modules (hereinafter denoted as "ADCs") 211A and 211B. ADCs 211A and 211B each comprise a processor and a storage device that stores autonomous driving software using an API described hereinafter, and are each configured to be capable of executing the autonomous driving software by the processor. Sensor for perception 212 includes a sensor that obtains information (hereinafter also referred to as "environmental information") indicating an environment external to vehicle 1. Sensor for perception 212 may include at least one of a camera, a millimeter wave radar, and a lidar. Sensor for pose 213 obtains information (hereinafter also referred to as "pose information") for a pose of vehicle 1. Sensor for pose 213 may include a variety of types of sensors that sense an acceleration, angular velocity, and position of vehicle 1. HMI 218 includes an input device and a notification device.

Base vehicle 120 comprises a brake system 121, a steering system 122, a powertrain system 123, an active safety system 125, and a body system 126. In the present embodiment, each system comprises an electronic control unit (hereinafter also referred to as "ECU").

In vehicle 1, a control system for behaviors (travelling, stopping, and turning) of vehicle 1 has redundancy. ADCs 211A and 211B provide instructions to a main control system and a subordinate control system, respectively. VCIB 110 includes a control unit 111A for the main control system and a control unit 111B for the subordinate control system. Control units 111A and 111B may directly communicate with each system or may communicate therewith via integrated control manager 130 shown in FIG. 1.

Brake system 121 includes a brake device, an operation unit (e.g., a brake pedal) that receives a braking operation from a user, and brake control units 121A and 121B. Steering system 122 includes a steering device, an operation unit that receives a steering operation from the user, and steering control units 122A and 122B. Powertrain system 123 includes a shift device (not shown), an EPB device 123A, a P-Lock device 123B, and a propulsion system 123C. "EPB" means an electric parking brake, and "P-Lock" means parking lock.

The shift device determines a shift range and switches a propulsion direction and a shift mode for base vehicle 120 in accordance with the determined shift range. The shift device includes a transmission mechanism and an operation unit that receives a shifting operation from the user. Propulsion system 123C comprises a vehicle drive device, an operation unit (e.g., an accelerator pedal) that receives an accelerating operation from the user, and a propulsion control unit that controls the vehicle drive device. The vehicle drive device imparts a propulsive force to a wheel in a propulsion direction indicated by the shift range. The propulsive force accelerates base vehicle 120. The vehicle drive device comprises a battery and a travelling motor that receives electric power from the battery.

EPB device 123A for example comprises a parking brake mechanism, an electric actuator, and an operation unit (e.g., an EPB switch) that receives an EPB request from the user. EPB device 123A may be configured to apply a braking force to a wheel by the electric actuator (e.g., a motor) to fix (or immobilize) the wheel. P-Lock device 123B for example comprises a parking lock mechanism, an actuator, and an operation unit (e.g., a hand brake lever) that receives a parking operation from the user. P-Lock device 123B may be configured to mechanically fix a rotational position of an output shaft of the transmission by a parking lock pole drivable by the actuator.

In the present embodiment, a signal (an API signal) defined with an application program interface (API) is used for communication between ADK 200 and VCIB 110. ADK 200 is configured to process a variety of types of signals defined with the API. ADK 200 outputs a variety of types of commands to VCIB 110 in accordance with the API. Hereinafter, the variety of types of commands output from ADK 200 to VCIB 110 will each also be referred to as an "API command". ADK 200 receives a variety of types of signals indicating a state of base vehicle 120 from VCIB 110 in accordance with the API. Hereinafter, the variety of types of signals that ADK 200 receives from VCIB 110 will each also be referred to as an "API status". The API command and the API status both correspond to the API signal.

In the present embodiment, ADK 200 uses API commands described below.

A vehicle mode command (hereinafter denoted as "VEMDCMD") is an API command to request a transition to an autonomous mode or a manual mode. The autonomous mode and the manual mode will be described hereinafter. A propulsion direction command is an API command to request switching a shift range (R/D). An acceleration command is an API command indicating acceleration of the vehicle. The acceleration command requests acceleration (+) and deceleration (-) for a direction indicated by a propulsion direction status described hereinafter. A front wheel steering angle command is an API command to request steering the front wheels of the vehicle. A brake hold command (hereinafter referred to as a "BH command") is an API command to request brake hold. An immobilization command is an API command to request application of or release from immobilization.

Some API commands used in vehicle 1 have been described above. VCIB 110 receives a variety of types of API commands from ADK 200. Upon receiving an API command from ADK 200, VCIB 110 converts the API command into a format for a signal executable by the controller of base vehicle 120. Hereinafter, an API command converted into a format of a signal executable by the controller of base vehicle 120 will also be referred to as an "internal command". Upon receiving an API command from ADK 200, VCIB 110 outputs to base vehicle 120 an internal command corresponding to the API command.

Hereinafter, the API status will be described. ADK 200 understands a state of base vehicle 120 for example through API statuses described below.

A vehicle mode status (hereinafter denoted as "VEMDST") is an API status indicating a state of a vehicle mode. The vehicle mode includes the manual mode and the autonomous mode. The manual mode is a vehicle mode in which the vehicle is under the control of a user (e.g., a driver). The autonomous mode is a vehicle mode in which the vehicle platform (including the base vehicle) is under the control of the autonomous driving kit. Initially (e.g., when the vehicle system is started), the vehicle mode is the manual mode. When the current vehicle mode is the manual mode, VEMDST indicates a corresponding value of "0", whereas when the current vehicle mode is the autonomous mode, VEMDST indicates a corresponding value of "1".

An autonomous driving ready status (hereinafter denoted as "VP_ATRDY") is an API status indicating whether preparation for switching from the manual mode to the autonomous mode (hereinafter referred to as "preparation for autonomous driving") is completed. When the preparation for autonomous driving is completed, VP_ATRDY indicates "1", whereas when the preparation for autonomous driving is not completed, VP_ATRDY indicates "0".

A brake hold prohibition status (hereinafter denoted as "BHPRST") is an API status indicating whether brake hold is prohibited. BHPRST indicates "0" when brake hold is permitted, and BHPRST indicates "1" when brake hold is prohibited.

A propulsion direction status is an API status indicating the current shift range. A moving direction status is an API status indicating a direction in which the vehicle moves. The moving direction status outputs a value of "0" when the vehicle moves forward, a value of "1" when the vehicle moves backward, and a value of "2" (Standstill) when all the wheels (four wheels) continue to indicate a speed of "0" for a predetermined period of time. A vehicle speed status is an API status indicating a speed of the vehicle in its longitudinal direction (e.g., moving direction). The vehicle speed status outputs an absolute value of vehicular speed. An immobilization status is an API status indicating a state of immobilization. The state of immobilized is, for example, a state of EPB device 123A and a state of P-Lock device 123B.

A failure status (hereinafter referred to as a "failure notification signal") is an API status indicating whether a failure is present or absent and where the failure is located. When there is no failure the failure notification signal indicates "0", whereas when there is a failure, the failure notification signal indicates a numerical value corresponding to where the failure is located (specifically, an integer other than "0"). In the present embodiment, when the brake device has a brake hold function failed, the failure notification signal indicates "1".

Some API statuses used in vehicle 1 have been described above. VCIB 110 receives values of sensing by a variety of types of sensors and state determination results from base vehicle 120 and outputs to ADK 200 a variety of types of API statuses indicating a state of base vehicle 120. VCIB 110 obtains an API status having a value set to indicate a state of base vehicle 120 and outputs the obtained API status to ADK 200.

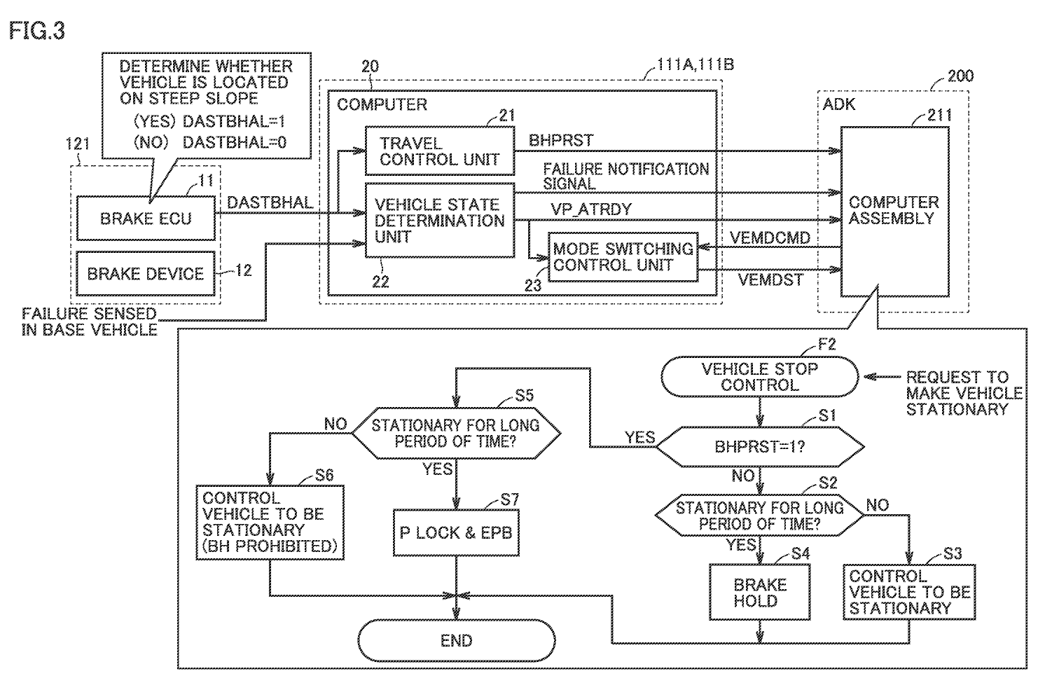

ADK 200 repeats performing a processing flow F1 shown in FIG. 1. The processing flow F1 and a processing flow F2 (FIG. 3) described hereinafter are basically performed by ADC 211A. When ADC 211A has an error, however, ADC 211B performs each process instead of ADC 211A. In a flowchart, "S" means a step.

In S101, ADK 200 determines whether the current vehicle mode of vehicle 1 is the autonomous mode based on VEMDST. When VEMDST indicates "1" (YES in S101), the control proceeds to S102. In contrast, when VEMDST indicates "0" (NO in S101), the control does not proceed to S102 and instead repeats S101.

In S102, ADK 200 creates a driving plan for autonomous driving, based on a result of sensing by a variety of types of sensors (e.g., environmental information and pose information) and an API status obtained from VCIB 110. The driving plan is data indicating a behavior of vehicle 1 targeted for a predetermined period of time. ADK 200 may calculate a behavior (a pose, etc.) of vehicle 1 and create a driving plan suitable for a state of vehicle 1 and an external environment. Subsequently, in S103, ADK 200 sends an API command to VCIB 110 to apply control requested by the created driving plan. As a result, an internal command corresponding to the API command is transmitted from VCIB 110 to base vehicle 120. The control requested by the driving plan is, for example, at least one of: acceleration control; deceleration control; steering control; controlling the vehicle to be stationary; and parking control. The API command corresponds to an instruction from ADK 200 to the vehicle system (the system of base vehicle 120). ADK 200 may calculate a physical quantity requested by the driving plan for control (such as acceleration, a tire turning angle, etc.), and determine an API command based on the calculation result. In the autonomous mode, ADK 200 repeats S102 and S103. ADK 200 thus continues to control vehicle 1 to autonomously drive the vehicle. ADK 200 instructs the vehicle system in accordance with the driving plan created in S102.

FIG. 3 illustrates ADK 200 controlling the vehicle to be stationary.

Referring to FIG. 3, brake system 121 of vehicle 1 includes a brake ECU 11 and a brake device 12. Brake ECU 11 is a computer comprising a processor and a storage device. Brake ECU 11 transmits to computer 20 a signal indicating whether vehicle 1 is located on a steep slope (hereinafter denoted as "DASTBHAL"). DASTBHAL indicates "1" when vehicle 1 is located on a steep slope, and indicates "0" when vehicle 1 is not located on a steep slope.

Specifically, brake ECU 11 detects a tilt of vehicle 1 based on acceleration sensed by acceleration sensor 140 (e.g., a G sensor). Acceleration sensor 140 for example senses a reactive force (e.g., acceleration) necessary to keep vehicle 1 stationary against gravity. Acceleration sensed by acceleration sensor 140 changes with the tilt of vehicle 1. That is, a value obtained from sensing by acceleration sensor 140 indicates a tilt of vehicle 1. In the present embodiment, acceleration sensor 140 functions as a sensor to sense a tilt of vehicle 1. By sensing a tilt of vehicle 1 by a sensor, whether vehicle 1 is located on a steep slope can be determined with high accuracy. In addition to or in please of the acceleration sensor, a tilt sensor, a gyro sensor, or an inertial measurement unit (IMU) may be used to sense a tilt of vehicle 1. Any method may be used to sense a steep slope. The vehicle system may determine whether vehicle 1 is located on a steep slope by matching map information with positional information of vehicle 1.

When acceleration sensor 140 senses that vehicle 1 tilts at an angle equal to or larger than a reference angle, brake ECU 11 sets "1" for DASTBHAL and transmits that DASTBHAL (a first state signal) to computer 20. Vehicle 1 tilted at an angle equal to or larger than the reference angle means that vehicle 1 is located on a steep slope. In contrast, when acceleration sensor 140 senses that vehicle 1 tilts at an angle smaller than the reference angle, brake ECU 11 sets "0" for DASTBHAL and transmits that DASTBHAL (a second state signal) to computer 20. Vehicle 1 tilted at an angle smaller than the reference angle means that vehicle 1 is not located on a steep slope. The reference angle may previously be set based on a specification of brake device 12 (a specification for the brake hold function, in particular).

In the present embodiment, brake ECU 11 having the above function is provided in brake control unit 121A. This is not exclusive, however, and brake ECU 11 having the above function may be provided in both brake control units 121A and 121B.

Brake device 12 is configured to decelerate vehicle 1. Brake device 12 may be a hydraulic disk brake device. Brake device 12 is controlled by each of brake control units 121A and 121B. In the present embodiment, brake device 12 has the brake hold function. Brake hold is a process in which brake device 12 holds vehicle 1 stationary. Brake device 12 functions as a service brake and is used not only while the vehicle is stationary but also while the vehicle is traveling. In the autonomous mode, brake device 12 applies a braking force to a wheel of vehicle 1 in response to an instruction issued from ADK 200. In the manual mode, brake device 12 applies a braking force to a wheel of vehicle 1 in response to a braking operation performed by the user (e.g., driver). For example, while vehicle 1 travels, the user can depress the brake pedal to decelerate vehicle 1 to make the vehicle stationary. When vehicle 1 made stationary is thereafter held stationary for example for waiting at traffic lights, brake hold may be applied. Vehicle 1 may apply brake hold in response to an instruction (e.g., a BHSW operation) received from the user. When brake hold is applied, a braking force applied to a wheel is also held while the user releases his/her foot from the brake pedal. For example, for a hydraulic brake device, maintaining a hydraulic pressure that is applied to make the vehicle stationary while brake hold is applied holds the braking force.

EPB device 123A and P-Lock device 123B each correspond to a parking device used only while the vehicle is stationary. The parking device is not used while vehicle 1 is traveling. The parking device acts to fix vehicle 1 in a stationary state to bring the vehicle to a parked state. In the parked state, vehicle 1 is prohibited from traveling. Once vehicle 1 has entered the parked state, shutting down (powering off) the system of base vehicle 120 (including a variety of types of ECUs) is permitted. In the parked state, the vehicle system may be operated (powered on)/standstill (powered off), as switched in response to an instruction received from the user. Vehicle 1 resumes traveling after releasing the parked state while the vehicle system is in operation. While vehicle 1 is not in the parked state (e.g., while travelling or stationary), shutting down the vehicle system is prohibited.

In the present embodiment, computer 20 described hereinafter is provided in each of control units 111A and 111B. Computer 20 includes a travel control unit 21, a vehicle state determination unit 22, and a mode switching control unit 23. These units may have their functions embodied by a program stored in a storage device and a processor that executes a program. Alternatively, the units may have their functions embodied by hardware (e.g., electronic circuitry).

When travel control unit 21 receives DASTBHAL indicating "1", the travel control unit sets "1" for BHPRST and sends that BHPRST (a prohibition signal) to ADK 200. When travel control unit 21 receives DASTBHAL indicating "0", the travel control unit sets "0" for BHPRST and sends that BHPRST (a permission signal) to ADK 200.

Based on a signal (DASTBHAL) received from brake ECU 11, computer 20 can send BHPRST that matches a state of vehicle 1 (the prohibition signal/the permission signal) to ADK 200. Permission/prohibition of brake hold is thus switched depending on the state of vehicle 1, as appropriate. In the present embodiment, brake ECU 11 and computer 20 function as a "first controller" and a "second controller", respectively, according to the present disclosure.

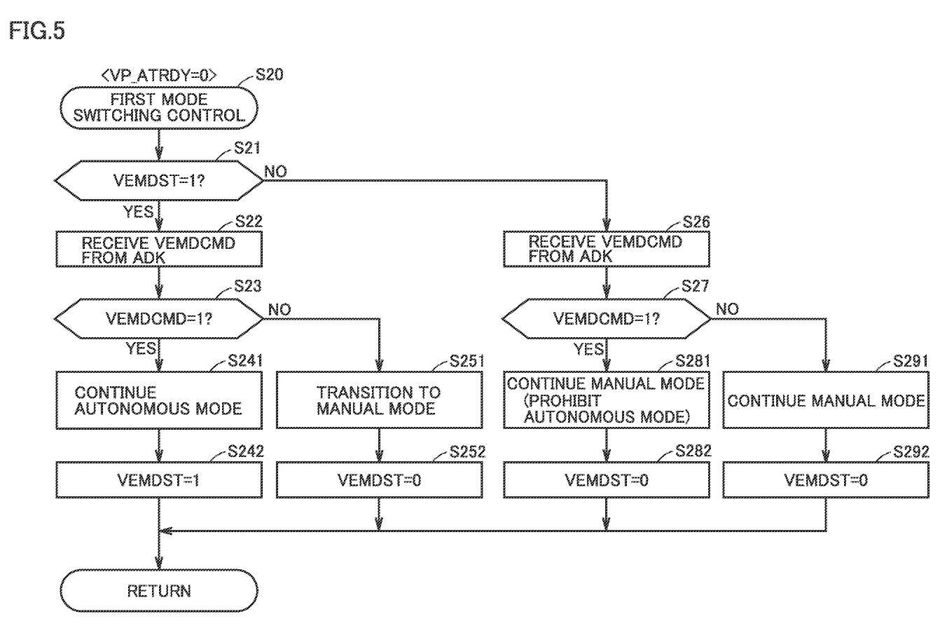

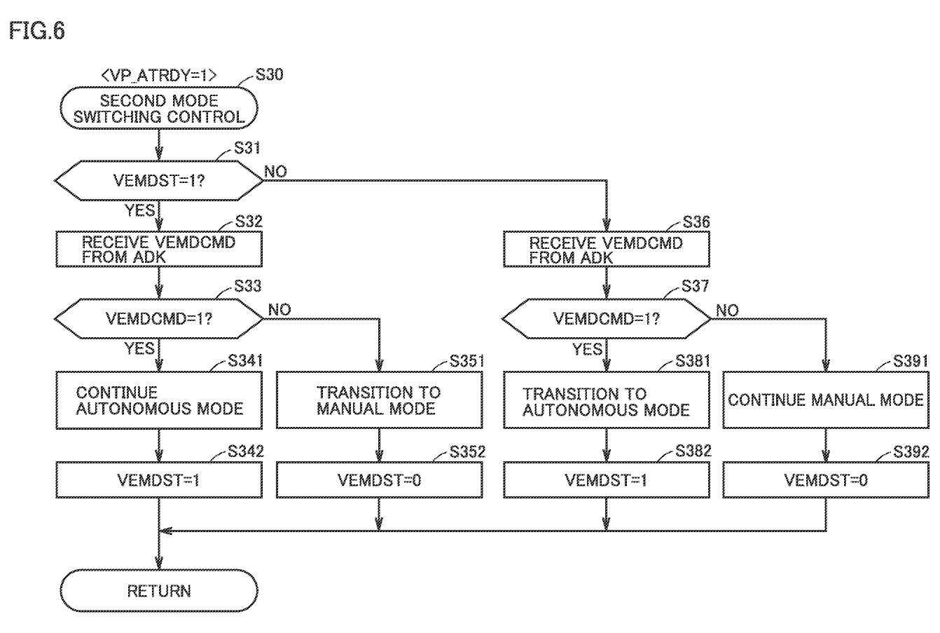

Vehicle state determination unit 22 sets values for VP_ATRDY and the failure notification signal based on information received from base vehicle 120, and sends those VP_ATRDY and failure notification signal to ADK 200. In the present embodiment, when vehicle state determination unit 22 receives DASTBHAL indicating "1", the vehicle state determination unit sets "0" for VP_ATRDY and sends that VP_ATRDY (a third state signal) to mode switching control unit 23 and ADK 200. VP_ATRDY indicating "0" means that vehicle 1 is not in a state in which the vehicle is switchable from the manual mode to the autonomous mode. When vehicle state determination unit 22 receives DASTBHAL indicating "0", the vehicle state determination unit sets "1" for VP_ATRDY and sends that VP_ATRDY to mode switching control unit 23 and ADK 200. VP_ATRDY indicating "1" means that vehicle 1 is in a state in which the vehicle is switchable from the manual mode to the autonomous mode. Mode switching control unit 23 sets a value for VEMDST based on VEMDCMD, VEMDST and VP_ATRDY, and subsequently sends that VEMDST to ADK 200 (see FIGS. 5 and 6 described hereinafter).

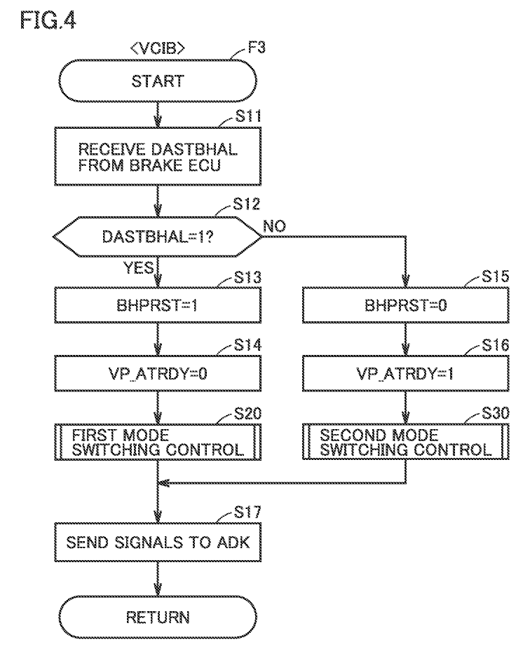

Each above process is performed in a processing flow F3 described hereinafter (FIG. 4). When computer 20 receives DASTBHAL indicating "1", the computer sends VP_ATRDY indicating "0" (the third state signal) to ADK 200. ADK 200 can thus determine whether to request VCIB 110 to switch modes after understanding a state of vehicle 1. This facilitates appropriate switching between the manual mode and the autonomous mode. It should be noted that the above embodiment can be modified as appropriate. Vehicle state determination unit 22 may also determine a value for VP_ATRDY while considering a parameter other than DASTBHAL for a state of vehicle 1.

Furthermore, when vehicle state determination unit 22 is notified from base vehicle 120 that the brake hold function of brake device 12 has failed, the vehicle state determination unit sets "1" for the failure notification signal and subsequently sends that failure notification signal (a fourth state signal) to ADK 200. ADK 200 can thus apply autonomous driving control after understanding a state of brake device 12. This facilitates appropriately applying autonomous driving control. The fourth state signal (the failure notification signal indicating "1") is sent separately from the prohibition signal (BHPRST indicating "1"). Thus, ADK 200 can perform different controls when ADK 200 receives the prohibition signal and when ADK 200 receives the fourth state signal. For example, when the brake hold function of brake device 12 does not fail and ADK 200 is required to hold vehicle 1 in the stationary state for a predetermined period of time or more for a predetermined purpose (e.g., boarding, alighting, loading, or unloading), ADK 200 may move vehicle 1 so that vehicle 1 is no longer located on a steep slope. ADK 200 may then stop vehicle 1 in a location other than the steep slope and apply brake hold.

In the present embodiment, ADK 200 is configured to be operable in an unmanned mode and a manned mode. The manned mode is a driving mode on the assumption that vehicle 1 is in a manned state. The unmanned mode is a driving mode in which vehicle 1 is autonomously driven regardless of whether vehicle 1 is in the manned state or an unmanned state. ADK 200 may switch the unmanned mode to the manned mode and vice versa in response to a request received from the user. The user may set either the unmanned mode or the manned mode for ADK 200 through HMI 150 or 218. ADK 200 may request the user to conduct a predetermined authentication procedure, and only when the user is successfully authenticated, the ADK may switch the unmanned mode to the manned mode and vice versa in response to a request received from the user. In the unmanned mode, ADK 200 constantly outputs VEMDCMD indicating "1". In the manned mode, ADK 200 for example changes a value of VEMDCMD in response to a request received from the user and outputs the changed VEMDCMD. The user may set a value (0 or 1) for VEMDCMD to ADK 200 through HMI 150 or 218. ADK 200 may be configured to avoid setting "1" for VEMDCMD while receiving VP_ATRDY indicating "0" (the third state signal) in the manned mode. ADK 200 avoiding setting "1" for VEMDCMD means that ADK 200 does not request VCIB 110 to make a transition to the autonomous mode.

When a driving plan requests in S103 in FIG. 1 that the vehicle be controlled to be stationary, ADK 200 starts the processing flow F2 indicated in FIG. 3. The vehicle is controlled to be stationary at any of S3, S4, S6, and S7. ADK 200 repeats the processing flow F2 while the driving plan requests controlling the vehicle to be stationary.

In S1, ADK 200 determines whether brake hold is prohibited based on BHPRST. When BHPRST indicates "1" (YES in S1), the control proceeds to S5. In contrast, when BHPRST indicates "0" (NO in S1), the control proceeds to S2. In S2, ADK 200 determines whether the driving plan requests making the vehicle stationary for a long period of time.

While vehicle 1 is traveling, vehicle 1 is initially required to be brought into the stationary state. Accordingly, a decision of NO is made in S2 and the control proceeds to S3. In S3, ADK 200 decelerates vehicle 1. When vehicle 1 is equal to or higher in speed than a reference value, ADK 200 applies first deceleration control to reduce (or lower) vehicular speed. When vehicle 1 is lower in speed than the reference value, the ADK applies second deceleration control to make the vehicle stationary. When ADK 200 is requested to make vehicle 1 stationary while the vehicle is traveling at a high speed, ADK 200 applies the first deceleration control to sufficiently reduce vehicular speed and subsequently applies the second deceleration control to make vehicle 1 stationary. Specifically, ADK 200 uses an acceleration command indicating a negative (-) value to request base vehicle 120 for deceleration for the first or second deceleration control to apply the first or second deceleration control.

When the driving plan requests that vehicle 1 in the stationary state be held as it is in the same location for a predetermined period of time (hereinafter denoted as "Th1") or more, a decision of YES is made in S2, and the control proceeds to S4. In S4, ADK 200 uses the BH command to request base vehicle 120 for brake hold to thus apply brake hold by brake device 12. When the driving plan requests that the vehicle be stationary for a period of time shorter than Th1, a decision of NO is made in S2. In that case, for example, the second deceleration control is applied to maintain vehicle 1 in the stationary state (S3). In S3, brake hold is not prohibited. Accordingly, ADK 200 may apply brake hold by brake device 12 when the driving plan requests brake hold for a purpose other than making the vehicle stationary for a long period of time.

In S5, ADK 200 determines whether the driving plan requests that the vehicle be stationary for a long period of time. While vehicle 1 is traveling, a decision of NO is made in S5, and the control proceeds to S6. In S6, ADK 200 decelerates vehicle 1. S6 is basically the same as S3. It should be noted, however, that brake hold is prohibited in S6. When vehicle 1 is in the stationary state, ADK 200 confirms a period of time for which the driving plan requests that the vehicle be stationary. When the driving plan requests that vehicle 1 in the stationary state be held as it is in the same location for a predetermined period of time (hereinafter denoted as "Th2") or more, a decision of YES is made in S5, and the control proceeds to S7. In the present embodiment, Th1 and Th2 are set to the same time (of a fixed value). This is not exclusive, however, and Th1 and Th2 can each be set as desired. Th2 may be longer than Th1 or shorter than Th1. Th1 and Th2 may each be variable.

ADK 200 may obtain Th2 from VCIB 110. For example, when vehicle 1 is located on a steep slope, computer 20 may calculate Th2 using at least one of weather information, the slope's angle, the slope's direction (i.e., upward/downward), the vehicle's weight (e.g., a load), and how much brake device 12 is deteriorated, and the computer may send the calculated Th2 to ADK 200.

In S7, ADK 200 uses the immobilization command to instruct base vehicle 120 to actuate at least one of EPB device 123A and P-Lock device 123B. In the present embodiment, ADK 200 actuates both EPB device 123A and P-Lock device 123B in S7. In response to the instruction received from ADK 200, base vehicle 120 sets EPB device 123A to an ON state (operational state) and sets the shift range to P (parking), and subsequently performs parking lock by P-Lock device 123B. According to such control, ADK 200 can hold vehicle 1 in the same location for a long period of time without relying on the brake hold function of brake device 12 while receiving the prohibition signal. When the driving plan requests the parking control, ADK 200 executes a processing flow (not shown) different from the processing flow F2. In that case, ADK 200 actuates both EPB device 123A and P-Lock device 123B whatever value BHPRST may assume. ADK 200 may park vehicle 1 in a location that is not a steep slope.

FIG. 4 is a flowchart of mode switching control applied by VCIB 110. The mode switching control is a control to switch the manual mode to the autonomous mode and vice versa. The processing flow F3 shown in FIG. 4 is basically repeated by computer 20 of control unit 111A. However, when the main control system has an error, computer 20 of control unit 111B executes the processing flow F3 instead of computer 20 of control unit 111A.

Referring to FIG. 4, in S11, VCIB 110 receives DASTBHAL from brake ECU 11. VCIB 110 may request DASTBHAL from brake ECU 11. Subsequently, in S12, VCIB 110 determines whether vehicle 1 is located on a steep slope based on the received DASTBHAL. If DASTBHAL indicates "1" (YES in S12), VCIB 110 sets "1" for BHPRST in S13 and subsequently sets "0" for VP_ATRDY in S14. Thereafter, the control proceeds to S20. In contrast, when DASTBHAL indicates "0" (NO in S12), VCIB 110 sets "0" for BHPRST in S15, and subsequently sets "1" for VP_ATRDY in S16. Thereafter, the control proceeds to S30.

FIG. 5 is a flowchart showing details of first mode switching control (S20).

Referring to FIG. 5, in S21, VCIB 110 determines whether the current vehicle mode of vehicle 1 is the autonomous mode based on VEMDST. When VEMDST indicates "1" (YES in S21), the control proceeds to S22. When VEMDST indicates "0" (NO in S21), the control proceeds to S26.

In S22, VCIB 110 receives VEMDCMD from ADK 200. VCIB 110 may request VEMDCMD from ADK 200. Subsequently, in S23, VCIB 110 determines whether the received VEMDCMD indicates "1". When VEMDCMD indicates "1" (YES in S23), VCIB 110 continues the autonomous mode in S241, and sets "1" for VEMDST in S242. In contrast, when VEMDCMD indicates "0" (NO in S23), VCIB 110 switches the vehicle mode to the manual mode in S251, and sets "0" for VEMDST in S252.

In S26, as well as in S22, VCIB 110 receives VEMDCMD from ADK 200. Subsequently, in S27, VCIB 110 determines whether the received VEMDCMD indicates "1". When VEMDCMD indicates "1" (YES in S27), VCIB 110 continues the manual mode in S281, and sets "0" for VEMDST in S282. In this way, the manual mode is continued even when VEMDCMD requests a transition to the autonomous mode. In contrast, when VEMDCMD indicates "0" (NO in S27), VCIB 110 continues the manual mode in S291, and sets "0" for VEMDST in S292.

When VEMDST is set in any of S242, S252, S282, and S292, the processing flow shown in FIG. 5 ends, and the control proceeds to S17 in the processing flow F3 (FIG. 4).

FIG. 6 is a flowchart showing details of second mode switching control (S30).

Referring to FIG. 6, in S31, VCIB 110 determines whether the current vehicle mode of vehicle 1 is the autonomous mode based on VEMDST. When VEMDST indicates "1" (YES in S31), the control proceeds to S32. S32 and the following S33, S341, S342, S351, and S352 are identical to S22, S23, S241, S242, S251, and S252 in FIG. 5, respectively, and accordingly, will not be described.

When VEMDST indicates "0" (NO in S31), the control proceeds to S36. In S36, VCIB 110 receives VEMDCMD from ADK 200. Subsequently, in S37, VCIB 110 determines whether the received VEMDCMD indicates "1". When VEMDCMD indicates "1" (YES in S37), VCIB 110 switches the vehicle mode to the autonomous mode in S381, and sets "1" for VEMDST in S382. In contrast, when VEMDCMD indicates "0" (NO in S37), VCIB 110 continues the manual mode in S391, and sets "0" for VEMDST in S392.

When VEMDST is set in any of S342, S352, S382, and S392, the processing flow shown in FIG. 6 ends, and the control proceeds to S17 in the processing flow F3 (FIG. 4).

Referring to FIG. 4 again, in S17, VCIB 110 sends BHPRST, VP_ATRDY, and VEMDST set in the processing flow F3 to ADK 200. Thereafter, the control returns to the initial step (S11).

As has been described above, in the present embodiment, VP 100 corresponds to an example of a "vehicle allowing an autonomous driving kit to be mounted thereto" according to the present disclosure. VP 100 includes VCIB 110 and base vehicle 120. A system incorporated in base vehicle 120 corresponds to an example of a "vehicle system" according to the present disclosure. Furthermore, ADK 200 attached to VP 100 executes the processing flows F1 and F2 (FIGS. 1 and 3). VCIB 110 executes the processing flow F3 (FIGS. 4 to 6). VCIB 110 is configured to switch a manual mode to an autonomous mode and vice versa in response to a request received from ADK 200 (see FIGS. 5 and 6). The manual mode is a mode in which the vehicle system is under control of a user. The autonomous mode is a mode in which the vehicle system is under control of ADK 200.

When vehicle 1 is located on a steep slope, VCIB 110 sends to ADK 200 a prohibition signal indicating that brake hold by brake device 12 is prohibited (in S13 and S17 in FIG. 4). Brake hold is thus prohibited in controlling the vehicle to be stationary (S6 and S7 in the processing flow F2). This can prevent brake device 12 from applying insufficient braking force as brake device 12 is excessively heated while brake hold is applied.

Furthermore, vehicle 1 tends to be driven unstably in a transitional period such as immediately after a transition is made from the manual mode to the autonomous mode. When vehicle 1 is located on a steep slope, and ADK 200 starts autonomously driving vehicle 1 in an unstable state, the ADK may does so with reduced accuracy. Accordingly, in VP 100 according to the above embodiment, VCIB 110 continues the manual mode in response to ADK 200 requesting VCIB 110 to switch the manual mode to the autonomous mode while vehicle 1 is driven in the manual mode and also located on a steep slope (in S281 in FIG. 5). Thus, vehicle 1 is also appropriately drivable on a steep slope.

While embodiments have been described in the present disclosure, the presently disclosed embodiments should be considered to be illustrative and non-limiting in any respect. The scope of the present disclosure is defined by the terms of the claims and intended to encompass to any modification within the meaning and scope equivalent to the terms of the claims.

What is claimed is:

1. A vehicle allowing an autonomous driving kit to be mounted thereto, the vehicle comprising:
a vehicle control interface box; and
a vehicle system,
the vehicle system including a brake device configured to decelerate the vehicle,
the vehicle control interface box being configured to send a prohibition signal to the autonomous driving kit while the vehicle is located on a steep slope, the prohibition signal indicating that brake hold by the brake device is prohibited,
the vehicle control interface box being configured to switch a manual mode to an autonomous mode and vice versa in response to a request received from the autonomous driving kit, the manual mode being a mode in which the vehicle system is under control of a user, the autonomous mode being a mode in which the vehicle system is under control of the autonomous driving kit,
the vehicle control interface box being configured to continue the manual mode in spite of the autonomous driving kit requesting the vehicle control interface box to switch the manual mode to the autonomous mode while the vehicle is driven in the manual mode and also located on the steep slope.

2. The vehicle according to claim 1, wherein
the vehicle system includes a sensor and a first controller, the sensor being configured to sense that the vehicle tilts,
the vehicle control interface box includes a second controller,
the first controller is configured to:
in response to the sensor sensing that the vehicle tilts at an angle equal to or larger than a reference angle, transmit to the second controller a first state signal indicating that the vehicle is located on the steep slope; and
in response to the sensor sensing that the vehicle tilts at an angle smaller than the reference angle, transmit to the second controller a second state signal indicating that the vehicle is not located on the steep slope, and
the second controller is configured to:
upon receiving the first state signal, send the prohibition signal to the autonomous driving kit; and
upon receiving the second state signal, send to the autonomous driving kit a permission signal indicating that the brake hold by the brake device is permitted.

3. The vehicle according to claim 2, wherein the second controller is configured to send a third state signal to the autonomous driving kit upon receiving the first state signal, the third state signal indicating that the vehicle is not switchable from the manual mode to the autonomous mode.

4. The vehicle according to claim 1, wherein the vehicle control interface box is configured to send a fourth status signal different from the prohibition signal to the autonomous driving kit in response to the brake device having a brake hold function failed.

5. The vehicle according to claim 1, wherein
the vehicle comprises the autonomous driving kit,
the vehicle system further includes at least one of a parking lock device and an electric parking brake device,
the autonomous driving kit is configured to operate in the autonomous mode to create a driving plan for the vehicle and instruct the vehicle system in accordance with the created driving plan, and
the autonomous driving kit is configured to operate in the autonomous mode to instruct the vehicle system to actuate at least one of the parking lock device and the electric parking brake device in response to the determination that the autonomous driving kit receives the prohibition signal and the driving plan requests that the vehicle be held in a same location for a predetermined period of time or more.

6. A vehicle controller that controls a vehicle that comprises a vehicle system including a brake device and allows an autonomous driving kit to be mounted thereto, the vehicle controller comprising a vehicle control interface box configured to:
while the vehicle is located on a steep slope, send to the autonomous driving kit a prohibition signal indicating that brake hold by the brake device of the vehicle is prohibited;
in response to a request received from the autonomous driving kit, switch a manual mode to an autonomous mode and vice versa, the manual mode being a mode in which the vehicle system is under control of a user, the autonomous mode being a mode in which the vehicle system is under control of the autonomous driving kit; and
continue the manual mode in spite of the autonomous driving kit requesting the vehicle control interface box to switch the manual mode to the autonomous mode while the vehicle is driven in the manual mode and also located on the steep slope.
